(19) United States
(12) Patent Application Publication
(10) Pub. No.: US 2025/0076831 A1
(43) Pub. Date: Mar. 6, 2025

(54) OPTIMAL SENSORY ENVIRONMENT

(71) Applicant: Roger Mark Hamilton, Mt. Dora, FL (US)

(72) Inventor: Roger Mark Hamilton, Mt. Dora, FL (US)

(21) Appl. No.: 18/819,457

(22) Filed: Aug. 29, 2024

Related U.S. Application Data
(60) Provisional application No. 63/579,626, filed on Aug. 30, 2023.

(51) Int. Cl. G05B 15/02; G09B 5/02

(52) U.S. Cl. CPC G05B 15/02; G09B 5/02

(57) ABSTRACT

Systems and techniques for determining and providing an optimal sensory environment include steps of receiving a request for the optimal sensory environment, the request indicating the one or more users having optimal situation model attributes and including a desired outcome for a user activity to be performed by the one or more users, determining an optimal situation model by selecting one or more knowledge pyramids from a knowledge pyramid catalog based on the optimal situation model attributes of the one or more users and the desired outcome of the one or more users, determining the optimal sensory environment based on the determination of the optimal situation model, generating an optimal sensory environment output that comprises details of the optimal sensory environment, and sending the optimal sensory environment output to a source of the request for the optimal sensory environment.

### CROSS-REFERENCE TO RELATED APPLICATIONS

This application claims the benefit of U.S. Provisional Application Ser. No. 63/579,626 filed Aug. 30, 2023.

### BACKGROUND

The sights, sounds, and smells of a person's sensory environment can affect how the person performs an activity. In many instances, a person performs an activity in a sensory environment that is not optimized for the person or the activity, which can lead to undesired outcomes, such as inefficiency, inaccuracy, and heightened stress. In some instances, the person performs different activities in the same sensory environment, even though desired outcomes could be achieved if the sensory environment were optimized for each activity. Accordingly, there is a need for determining and providing optimal sensory environments based on person and activity.

### BRIEF SUMMARY

Systems and techniques for determining and providing an optimal sensory environment for a given activity and for a particular user or group of users are disclosed herein. Advantageously, by organizing user data and extrapolating user preferences, the systems and techniques predict and provide the optimal sensory environment while minimizing the time and information required from the user. Furthermore, the systems and techniques disclosed herein provide an output that includes details for the optimal sensory environment that is specific to a user's attributes, desired outcomes and/or goal, and limitations of their external environment.

Systems and techniques for determining and providing an optimal sensory environment include steps of receiving a request for the optimal sensory environment, the request indicating the one or more users having optimal situation model attributes and including a desired outcome for a user activity to be performed by the one or more users, determining an optimal situation model by selecting one or more knowledge pyramids from a knowledge pyramid catalog based on the optimal situation model attributes of the one or more users and the desired outcome of the one or more users, determining the optimal sensory environment based on the determination of the optimal situation model, generating an optimal sensory environment output that comprises details of the optimal sensory environment, and sending the optimal sensory environment output to a source of the request for the optimal sensory environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a representational diagram of a process flow for providing an optimal sensory environment.

FIG. 2 illustrates an example system for providing an optimal sensory environment.

FIG. 3 illustrates an example system flow for a system for determining and providing an optimal sensory environment.

FIG. 4 illustrates an example knowledge pyramid process for explaining a named concept.

FIG. 5 illustrates an example of delivering an optimal sensory environment to a user via a graphical user interface.

### DETAILED DESCRIPTION

Systems and techniques for determining and providing an optimal sensory environment for a given activity and for a particular user or group of users are disclosed herein. Advantageously, by organizing user data and extrapolating user preferences, the systems and techniques predict and provide the optimal sensory environment while minimizing the time and information required from the user. Furthermore, the systems and techniques disclosed herein provide an output that includes details for the optimal sensory environment that is specific to a user's attributes, desired outcomes and/or goal, and limitations of their external environment.

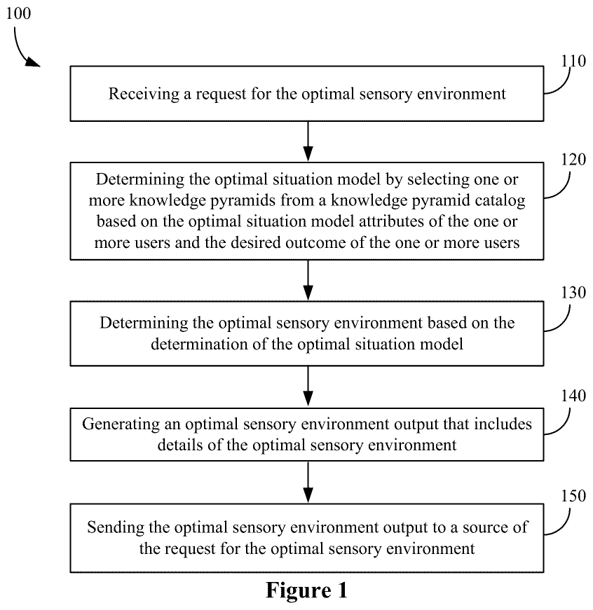

FIG. 1 illustrates a representational diagram of a process flow for providing an optimal sensory environment. Referring to FIG. 1, a method 100 of providing an optimal sensory environment for one or more users includes receiving (110) a request for the optimal sensory environment. The request indicates the one or more users having optimal situation model attributes and includes a desired outcome for a user activity to be performed by the one or more users. In some cases, the optimal situation model attributes for the one or more users include chemical, biological, psychological, and sociological physical characteristics (e.g., age, gender, psychophysical limitations), life activity characteristics (e.g., level of knowledge, level of skill, level of motivation), available resources (e.g., financial, time available), and environmental characteristics (e.g., home office, classroom, available public learning environments and characteristics of those locations). In some cases, the optimal situation model attributes further include whether the one or more users include a group of users and its group characteristics.

The method 100 further includes determining (120) the optimal situation model by selecting one or more knowledge pyramids from a knowledge pyramid catalog based on the optimal situation model attributes of the one or more users and the desired outcome of the one or more users and determining (130) the optimal sensory environment based on the determination of the optimal situation model. In some cases, determining (130) the optimal sensory environment based on the determination of the optimal situation model includes ranking activity methods and stimuli sets for the desired outcome based on values of the optimal situation model attributes as applied to the one or more knowledge pyramids, determining a ranked score of each of the activity methods and stimuli sets for the desired outcome, and selecting the optimal activity method and the optimal stimuli set for accomplishing the desired outcome for the one or more users based on the ranked score of each of the activity methods and stimuli sets. In some cases, selecting the optimal activity method and the optimal stimuli set is performed automatically by a system, or a user can select the optimal activity method and the optimal stimuli set from a list displayed to the user on a display.

In some cases, determining (120) the optimal sensory environment by selecting one or more knowledge pyramids from a knowledge pyramid catalog based on the optimal situation model attributes of the one or more users and the desired outcome of the one or more users and/or determining (130) the optimal sensory environment based on the determination of the optimal situation model can be accomplished and/or assisted by use of a numerical method, a statistical method, a predictive method, a machine learning method, or any similar method or technique.

In some cases, the optimal sensory environment includes a timeframe, an optimal activity method, and an optimal stimuli set. For example, for learning activities, the timeframe can include a real time activity, a topic lesson activity, a multi-lesson activity, a semester-based activity, and/or a lifetime activity. The optimal activity method can include, for example, recommended learning strategies, recommended instructional strategies, and other types of content for assisting the one or more users in accomplishing a desired outcome and/or goal. The optimal stimuli set can include, for example, attributes of one or more of sensory objects can include optimal visual stimuli (e.g., timing, location, duration, shape, size, color, texture, motion, brightness), optimal auditory stimuli, optimal tactile stimuli, optimal olfactory stimuli, optimal gustatory stimuli, and optimal kinesthetic stimuli. In some cases, the optimal activity method, and the optimal stimuli set can be determined, at least in part, by the optimal situation model attributes. For example, the optimal stimuli set can be determined based on what type of learner the one or more users are (e.g., visual learners, auditory learners, kinesthetic or hands-on learners). The optimal situation model can contain one or more timeframes, optimal activity methods, and optimal stimuli sets.

In some cases, the optimal sensory environment can contain activity optimal content objects, optimal content augmentation objects, optimal activity support objects, and non-useful objects, each object having its own sensory attributes (e.g., size, color, location, motion, aroma). Activity content objects (e.g., a textbook) are resources or stimuli used to perform the user activity. Content augmentation objects are resources or stimuli that strategically modify activity content objects (e.g., underline a key word, display a recommended learning strategy). Support objects (e.g., ambient room temperature; aroma of lavender) are resources or stimuli that facilitate performance of the user activity but are not related to the content of the user activity. Non-useful objects are resources or stimuli that are not related to the content of the user activity and do not facilitate performance of the user activity (e.g., background noise). In some cases, non-useful objects may be recommended for removal by the optimal sensory environment. The stimuli set that are generated can contain the sensory attributes of any combination of one or more activity content objects, content augmentation objects, activity support objects, and non-useful objects.

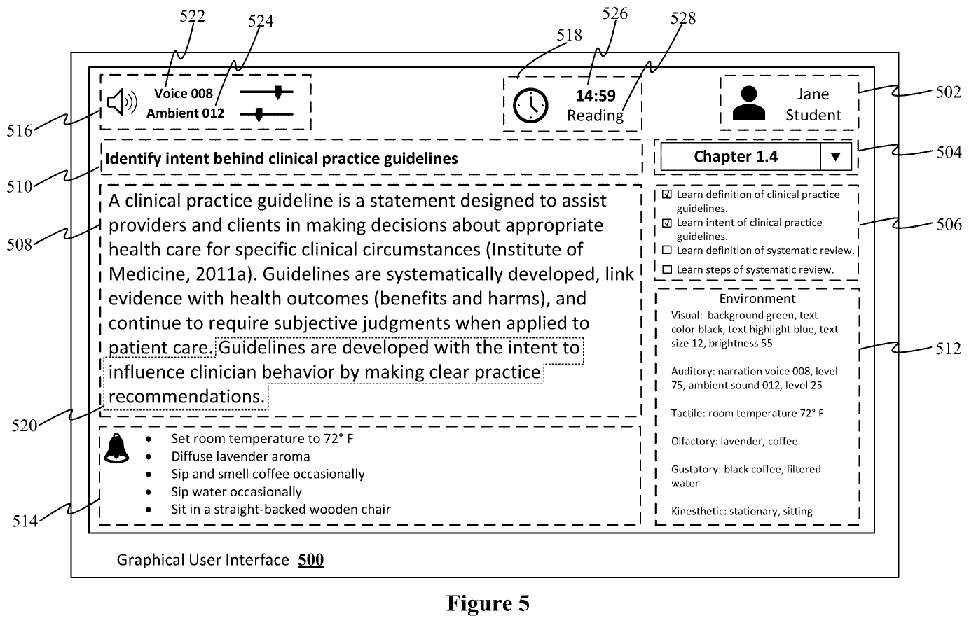

The method 100 further includes generating (140) an optimal sensory environment output that includes details of the optimal sensory environment and sending (150) the optimal sensory environment output to a source of the request for the optimal sensory environment. An example of an optimal sensory environment output is illustrated in FIG. 5. In some cases, generating (140) the optimal sensory environment output that includes details of the optimal sensory environment includes generating a description of the optimal sensory environment in tabulated format, generating a description of the optimal sensory environment in text format, and/or generating a description of the optimal sensory environment in the format of commands for a user-facing interface. In some cases, the user-facing interface includes a graphical user interface and a sound library. In some cases, the optimal sensory environment output can contain and/or recommend activity content objects, content augmentation objects, activity support objects, and non-useful objects.

In some cases, sending (150) the optimal sensory environment output to a source of the request for the optimal sensory environment includes delivering commands to a user interface. Delivering commands to the user interface includes delivering commands to modify the sensory attributes (e.g., location, size, and color) of visual objects in the graphical user interface, delivering commands to select and play a specific audio object from the sound library at a specific volume, and delivering commands to display on the graphical user interface the description of the optimal sensory environment in text format (e.g., display a “Ensure the learning environment is brightly lit” learning strategy).

In some cases, the method 100 further includes an accountability report that identifies the judgement decisions made in determining the optimal situation model and the decision strategies used to determine the optimal stimuli set based on the optimal situation model, and sending the accountability report to the source of the request for the optimal sensory environment.

In some cases, the method further includes generating feedback to the optimal situation model after the optimal stimuli set has been generated. For example, the method can include receiving an actual outcome for the one or more users, comparing the actual outcome for the one or more users to the desired outcome of the one or more users, and updating the selected one or more knowledge pyramids (e.g., current level of user knowledge in the user knowledge pyramid) based on the actual outcome for the one or more users. In cases where the actual sensory environment that the one or more users utilized differs from the optimal sensory environment, the one or more knowledge pyramids can be updated based on the actual outcome for the one or more users and the differences between the optimal sensory environment and actual sensory environment. In some cases, the selected one or more knowledge pyramids include a desired outcome knowledge pyramid. The desired outcome knowledge pyramid includes user preferences extrapolated from the desired outcome data and user preferences extrapolated from the user activity data.

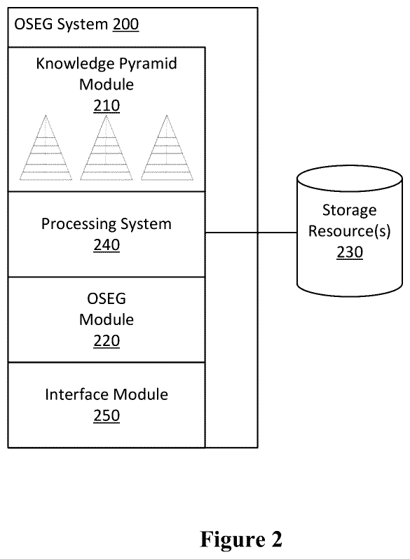

FIG. 2 illustrates an example system for providing an optimal sensory environment. An optimal sensory environment generation (OSEG) system 200 for determining and providing an optimal sensory environment includes a knowledge pyramid module 210. The OSEG system 200 further includes an OSEG module 220, a storage resource(s) 230, a processing system 240, and an interface module 250.

The knowledge pyramid module 210 may be implemented in the form of instructions and models stored on a storage resource, such as storage resource(s) 230, that are executed and applied by one or more hardware processors, such as processing system 240, to determine the optimal situation model by selecting one or more knowledge pyramids from a knowledge pyramid catalog stored in the storage resource(s) 230. In some cases, the knowledge pyramid module 210 can be used to perform one or more operations described with respect to FIGS. 1, 3 and 4.

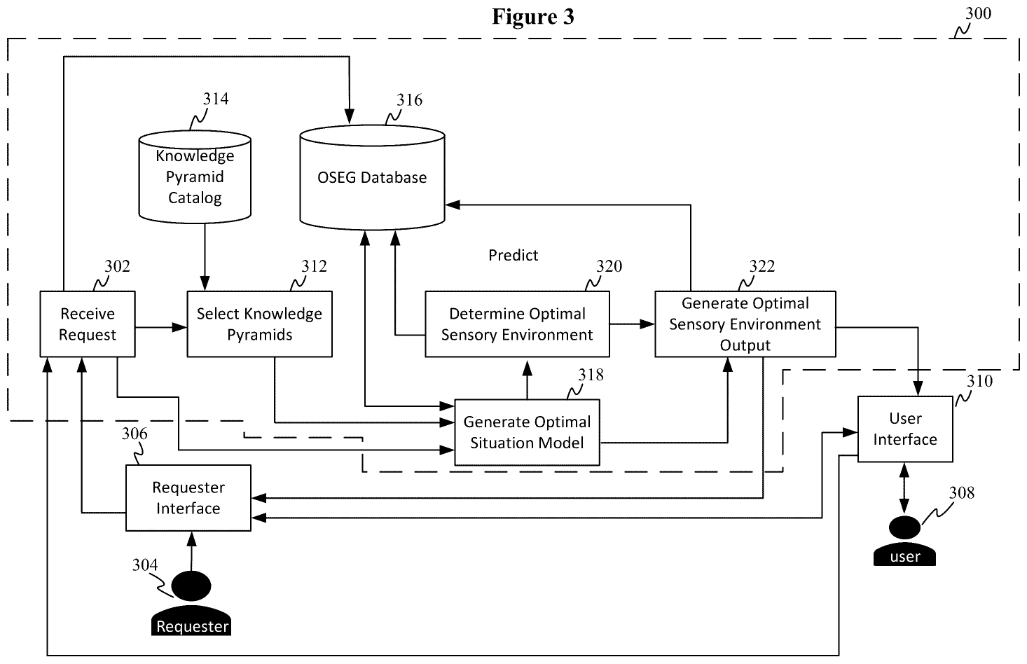

The OSEG module 220 can be used to determine and generate optimal sensory environments. In some cases, the OSEG models may be stored at the storage resource(s) 230 and/or at an external storage resource. In some cases, the OSEG module 220 can be used to perform one or more operations described with respect to FIGS. 1 and 3.

The storage resource(s) 230 can be implemented as a single storage device but can also be implemented across multiple storage devices or sub-systems co-located or distributed relative to each other. Storage resource(s) 230 can include storage devices and/or sub-systems on which data and/or instructions are stored. For example, instructions, such as the method 100 described with respect to FIG. 1 and/or a knowledge pyramid catalog, can be stored on the storage resource(s) 230. A knowledge pyramid catalog can be stored at the storage resource 230. The storage resource 230 can also store OSEG data from previous requests for and outputs of an optimal sensory environment or from external sources. As used herein, it should be understood that in no case does “storage device” or “computer-readable storage media” consist of transitory media.

The processing system 240 can be implemented within a single processing device, chip, or package but can also be distributed across multiple processing devices, chips, packages, or sub-systems that cooperate in executing program instructions, such as the method 100 described with respect to FIG. 1. Processing system 240 can include general purpose central processing units (CPUs), graphics processing units (GPUs), field programmable gate arrays (FPGAs), application specific processors, and logic devices, as well as any other type of processing device, combinations, or variations thereof.

The interface module 250 may be implemented in the form of instructions and models stored on a storage resource, such as storage resource(s) 230, that are executed and applied by one or more hardware processors, such as embodied by processing system 240, to provide interfaces through which to receive requests for an optimal sensory environment, deliver descriptions of an optimal sensory environment and provide an optimal sensory environment, such as the optimal sensory environment output, and receive feedback on an optimal sensory environment. In some cases, the interface module 250 has its own dedicated hardware processor(s).

In some cases, the interface module 250 can be used to perform one or more operations described with respect to FIGS. 1, 3 and 5. In some cases, the interface module 250 includes a user interface and/or requestor interface as described with respect to FIG. 3. In some cases, the OSEG system 200 may be configured to receive input from a user through, for example, a keyboard, mouse, trackpad, touch pad, touch screen, microphone, or other input device. In some cases, the OSEG system 200 can include wired or wireless interfaces communicating with the “outside world” (e.g., external networks), for example, to receive user input and/or send an optimal sensory environment output to a user and/or requester.

FIG. 3 illustrates an example system flow for a system 300 for determining and providing an optimal sensory environment. Referring to FIG. 3, determining and providing an optimal sensory environment includes receiving (302) a request from a requester 304 via a requester interface 306 and/or from a user 308 via a user interface 310. Based on the request, knowledge pyramids are selected (312) from a knowledge pyramid catalog 314. Data from the request, the OSEG database 316, and, in some cases, values from the selected knowledge pyramids are combined and used to generate (318) the optimal situation model. The optimal situation model can then be used to determine (320) the optimal sensory environment. An optimal sensory environment output can then be generated (322) and sent to the requester 304 via the requester interface 306 and/or to the user 308 via the user interface 310. In some cases, the optimal sensory environment output can be sent to a sensory-adjacent device, such as a smart thermostat, a lighting system, and/or other similar sensory-adjacent devices. In some cases, the optimal sensory environment output sent to the sensory-adjacent devices can include instructions for the sensory-adjacent device to modify its output to conform with the optimal sensory environment. In some cases, the interface module includes input/output interfaces that include wired or wireless connections to a display.

In some cases, the system flow can include receiving feedback on how the system generated (322) and/or delivered the optimal sensory environment output. The OSEG database 316 receives and stores data from receiving (302) the request, generating (318) the optimal situation model, determining (320) the optimal sensory environment, and generating (322) the optimal sensory environment output.

In some cases, the user interface 310 and/or requester interface 306 is included in the system 300. In some cases, the user interface 310 receives and sends the request for the optimal sensory environment.

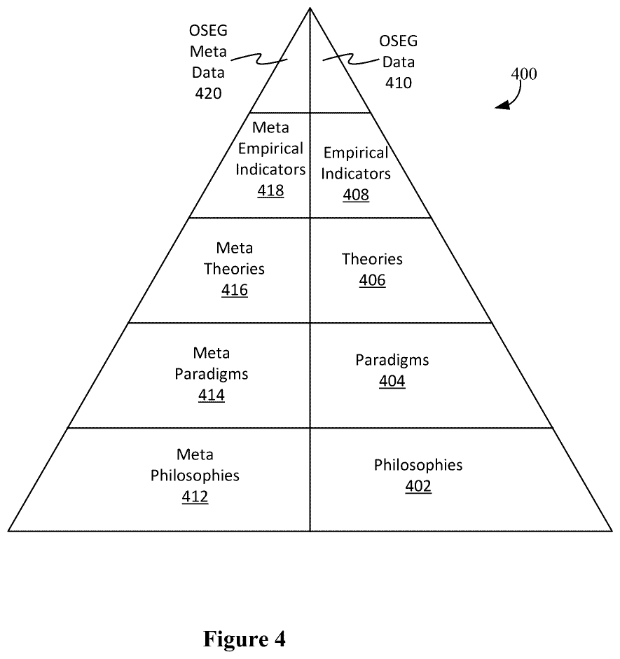

FIG. 4 illustrates a knowledge pyramid for explaining a named concept.

Referring to FIG. 4, a knowledge pyramid 400 of a concept is a hierarchical collection of assumptions about that concept organized into levels from bottom to top. In some cases, concepts of a knowledge pyramid 400 can include user profile, user activity, desired outcome, user history, resources, sensory environment, and feedback. In some cases, a knowledge pyramid 400 can be a user knowledge pyramid, a goals knowledge pyramid, a life activity knowledge pyramid, a resources knowledge pyramid, an environment knowledge pyramid, an optimal environment generation knowledge pyramid, and a decision-making knowledge pyramid. Furthermore, one or more knowledge pyramids may be selected based on the desired outcome and the optimal situation model attributes included in the request for the optimal sensory environment. The levels of a knowledge pyramid 400 include philosophies 402, paradigms 404, theories 406, empirical indicators 408, and OSEG data 410. The vertical line in the knowledge pyramid 400 divides each level into an organizing structure (the “meta-” on the left side) and one or more instances of that level using that structure (on the right side). For example, meta philosophies 412, meta paradigms 414, meta theories 416, meta empirical indicators 418, and meta OSEG data 420 are also included in the knowledge pyramid 400. Each block of a knowledge pyramid will have at least one value (e.g., a named theory about the concept and/or a named empirical indicator with a value).

Philosophies 402 include epistemological, aesthetic, metaphysical, and ethical perspectives of the one or more users relating to the concept of the knowledge pyramid 400.

Paradigms 404 reflect a philosophical stance and provide alternative ways to view the subject matter of the concept of the knowledge pyramid 400.

Theories 406 include the descriptive, explanatory, predictive, and prescriptive structuring of ideas that projects a tentative, purposeful, and systematic view of the concept of the knowledge pyramid 400.

Empirical indicators 408 bring forth the lower levels into a real world application. Empirical indicators can include mechanisms to obtain empirical data directly from the one or more users or the sensory environment. In some cases, empirical indicators 408 include prompts and/or questions for the one or more users. In some cases, empirical indicators 408 include mechanisms to receive feedback on the optimal sensory environment provided to the one or more users.

A knowledge pyramid 400 is specific to a named concept. For example, the OSEG primary knowledge pyramid supporting concepts can include user, goals, life activity, resources, environment, and decision-making. Each primary or supporting concept can have its own knowledge pyramid, and the aggregate of the knowledge pyramids, when individually and collectively optimized, constitutes the optimal situation model. Furthermore, one or more knowledge pyramids may be created or selected based on the desired outcome and the optimal situation model attributes included in the request for the optimal sensory environment.

The OSEG knowledge pyramid is the primary concept supported by the other knowledge pyramids in the optimal situation model. For example, the OSEG knowledge pyramid is the sum of all knowledge pyramid values (e.g., a named theory value, an empirical indicator value) in the blocks of the supporting knowledge pyramids plus concept-unique variable values. The OSEG data 410 can include the data related to OSEG experiences. In some cases, the OSEG data 410 includes data from external sources.

The user knowledge pyramid can include the role of the one or more users (e.g., student or teacher for the learning activity) and personal information such as chemical, biological, psychological, and sociological data. For example, the user knowledge pyramid can include the psychophysical sensory capabilities of a specific user (e.g., colorblind, other physiological disabilities). In some cases, a user can include an animal or plant with their phenotypical attributes, or an inanimate object (e.g., supercomputer).

The life activity knowledge pyramid can include activities (e.g., health, learning, creativity) conducted in the optimal sensory environment that lead to goal achievement.

The goals knowledge pyramid can include the desired outcome(s) of the user activity. In some cases, the goals knowledge pyramid includes metrics of success for the user activity. Metrics of success for the user activity can be activity-focused (e.g., effectiveness, time efficiency, activity completion, accuracy) and/or user-focused (e.g., user knowledge level, motivation).

The resources knowledge pyramid can include the finite resources available to the user (e.g., financial, time, energy) when the user performs the user activity. For example, optimal sensory stimuli set generation around the user can continuously occur until a goal is achieved, the user voluntarily quits, or a resource is exhausted.

The environment knowledge pyramid can include stimuli set generation capabilities (e.g., screen brightness, text highlight color, aroma generation, motion generation). Furthermore, it can include capabilities to detect changes in the situation model (e.g., a thermostat for ambient temperature).

The decision-making knowledge pyramid can include judgement strategies used for determining optimal situation model values (e.g., strategies such as machine learning algorithms) and decision strategies (e.g., multiattribute utility theory) used for determining the optimal sensory environment given the optimal situation model.

A situation model is optimized when it is accurate, inter-pyramidal congruent (i.e., level definitions have the same meaning for each pyramid), intra-pyramidal coherent (i.e., all levels are logically supported by the levels below), and inter-pyramidal coherent (i.e., all the pyramids together constitute a logical whole).

FIG. 5 illustrates an example of delivering an optimal sensory environment output to a user via a graphical user interface. Referring to FIG. 5, a graphical user interface (GUI) 500 can display an optimal sensory environment output that describes the optimal sensory environment and includes recommendations for performing the user activity. In the example view, the user is a nursing student and the user activity is learning a chapter in a nursing textbook.

As can be seen, the GUI 500 for the optimal sensory environment output includes a user icon 502, an activity menu 504, an activity progress window 506, an activity content window 508, a desired outcome window 510, an optimal environment description window 512, a notification window 514, a sound window 516, and a timer window 518.

Advantageously, the GUI 500 for the optimal sensory environment output provides the optimal sensory environment both directly and indirectly. The optimal sensory environment is provided directly through the arrangement, color, and size of objects in the windows which are used to perform the user activity and through sounds that can augment the user activity. The optimal sensory environment is provided indirectly through descriptions and notifications that the user may act on to further optimize the sensory environment (e.g., display a recommended “Eat, drink, bite, or chew while learning” learning strategy).

For example, to start the user activity, the nursing student can select a user profile from the user icon 502 and select a chapter from a nursing textbook from the activity menu 504. The nursing student can monitor progress in the activity progress window 506. The nursing student can perform the activity in the activity content window 508. The nursing student can view the current desired outcome in the desired outcome window 510. In the example, reading the chapter of the nursing textbook is an activity with multiple desired outcomes. The desired outcomes are learning goals to help the nursing student comprehend the material in the textbook.

The GUI 500 for the optimal sensory environment output further provides the optimal sensory environment directly through modifying the arrangement, color, and size of objects in the activity menu 504, the activity progress window 506, the activity content window 508, and the desired outcome window 510. The GUI 500 for the optimal sensory environment output further provides the optimal sensory environment directly by prompting sounds. In the example, the user-highlighted text 520 has a color optimized for the nursing student's preferences and the activity of learning the textbook chapter. The highlighted text can be narrated by a voice option 522 optimized for the nursing student's preferences and the activity of learning the textbook chapter.

The GUI 500 for the optimal sensory environment output further provides the optimal sensory environment directly by controlling the activity duration. Activity duration is displayed in the timer window 518. The timer window contains the activity timer 526 and the current activity 528. The activity timer 526 is optimized for the nursing student and the activity of learning the nursing textbook chapter. The activity timer 526 can prompt new notifications to display in the notification window 514. For example, when the activity timer 526 countdown reaches “0:00”, the current activity 528 can change from “Learning” to “Break”, a new activity timer 526 countdown can start, and the notification window 514 can display notifications for the nursing student to stand up, stretch, or grab a snack. The activity timer 526 can also prompt a new desired outcome to display in the desired outcome window 510.

In the example, the GUI 500 for the optimal sensory environment output further provides the optimal sensory environment indirectly through displaying text in the optimal environment description window 512 and the notification window 514. The nursing student can read the text and take action to modify aspects of the sensory environment that are in the nursing student's control, including sounds. The nursing student can select sounds and adjust sound levels in the sound window 516. In the example, sounds include narration voice options 522 and background music options 524.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for providing an optimal sensory environment for one or more users comprising:
receiving a request for the optimal sensory environment, the request indicating the one or more users having optimal situation model attributes and comprising a desired outcome for a user activity to be performed by the one or more users;
determining an optimal situation model by selecting one or more knowledge pyramids from a knowledge pyramid catalog based on the optimal situation model attributes of the one or more users and the desired outcome of the one or more users;
determining the optimal sensory environment based on the determination of the optimal situation model;
generating an optimal sensory environment output that comprises details of the optimal sensory environment; and
sending the optimal sensory environment output to a source of the request for the optimal sensory environment.

2. The method of claim 1, wherein the optimal sensory environment comprises a timeframe, an optimal activity method, and an optimal stimuli set.

3. The method of claim 2, where the optimal stimuli set comprises one or more of optimal visual stimuli, optimal auditory stimuli, optimal tactile stimuli, optimal olfactory stimuli, optimal gustatory stimuli, and optimal kinesthetic stimuli.

4. The method of claim 2, wherein determining the optimal sensory environment based on the determination of the optimal situation model comprises:
ranking activity methods and stimuli sets for the desired outcome based on values of the optimal situation model attributes as applied to the one or more knowledge pyramids;
determining a ranked score of each of the activity methods and stimuli sets for the desired outcome; and
selecting the optimal activity method and the optimal stimuli set for accomplishing the desired outcome for the one or more users based on the ranked score of each of the activity methods and stimuli sets.

5. The method of claim 1, further comprising:
receiving an actual outcome for the one or more users;
comparing the actual outcome for the one or more users to the desired outcome of the one or more users; and
updating the selected one or more knowledge pyramids based on the actual outcome for the one or more users.

6. The method of claim 1, wherein the optimal situation model attributes of the one or more users comprise chemical characteristics, biological characteristics, psychological characteristics, and sociological characteristics.

7. A system for providing an optimal sensory environment comprising:
a processor;
a storage; and
instructions stored on the storage that when executed by the processor, cause the processor to:
receive a request for the optimal sensory environment, the request indicating one or more users having optimal situation model attributes and comprising a desired outcome for a user activity to be performed by the one or more users;
determine an optimal situation model by selecting one or more knowledge pyramids from a knowledge pyramid catalog based on the optimal situation model attributes of the one or more users and the desired outcome of the one or more users;
determine the optimal sensory environment based on the determination of the optimal situation model;
generate an optimal sensory environment output that comprises details of the optimal sensory environment; and
send the optimal sensory environment output to a source of the request for the optimal sensory environment.

8. The system of claim 7, wherein the optimal sensory environment comprises a timeframe, an optimal activity method, and an optimal stimuli set.

9. The system of claim 8, where the optimal stimuli set comprises one or more of optimal visual stimuli, optimal auditory stimuli, optimal tactile stimuli, optimal olfactory stimuli, optimal gustatory stimuli, and optimal kinesthetic stimuli.

10. The system of claim 8, wherein the instructions that when executed cause the processor to determine the optimal sensory environment based on the determination of the optimal situation model comprise instructions that when executed cause the processor to:
rank activity methods and stimuli sets for the desired outcome based on values of the optimal situation model attributes as applied to the one or more knowledge pyramids;
determine a ranked score of each of the activity methods and stimuli sets for the desired outcome; and
select the optimal activity method and the optimal stimuli set for accomplishing the desired outcome for the one or more users based on the ranked score of each of the activity methods and stimuli sets.

11. The system of claim 7, wherein the instructions further comprise instructions that when executed cause the processor to:
receive an actual outcome for the one or more users;
compare the actual outcome for the one or more users to the desired outcome of the one or more users; and
update the selected one or more knowledge pyramids based on the actual outcome for the one or more users.

12. The system of claim 7, wherein the optimal situation model attributes of the one or more users comprise chemical characteristics, biological characteristics, psychological characteristics, and sociological characteristics.

13. One or more storage media having instructions stored thereon that when executed by a processor, cause the processor to at least:
receive a request for an optimal sensory environment, the request indicating one or more users having optimal situation model attributes and comprising a desired outcome for a user activity to be performed by the one or more users;
determine an optimal situation model by selecting one or more knowledge pyramids from a knowledge pyramid catalog based on the optimal situation model attributes of the one or more users and the desired outcome of the one or more users;
determine the optimal sensory environment based on the determination of the optimal situation model;
generate an optimal sensory environment output that comprises details of the optimal sensory environment; and
send the optimal sensory environment output to a source of the request for the optimal sensory environment.

14. The one or more storage media of claim 13, wherein the optimal sensory environment comprises a timeframe, an optimal activity method, and an optimal stimuli set.

15. The one or more storage media of claim 14, where the optimal stimuli set comprises one or more of optimal visual stimuli, optimal auditory stimuli, optimal tactile stimuli, optimal olfactory stimuli, optimal gustatory stimuli, and optimal kinesthetic stimuli.

16. The one or more storage media of claim 14, wherein the instructions that when executed cause the processor to determine the optimal sensory environment based on the determination of the optimal situation model comprise instructions that when executed cause the processor to:
rank activity methods and stimuli sets for the desired outcome based on values of the optimal situation model attributes as applied to the one or more knowledge pyramids;
determine a ranked score of each of the activity methods and stimuli sets for the desired outcome; and
select the optimal activity method and the optimal stimuli set for accomplishing the desired outcome for the one or more users based on the ranked score of each of the activity methods and stimuli sets.

17. The one or more storage media of claim 13, wherein the instructions further comprise instructions that when executed cause the processor to:
receive an actual outcome for the one or more users;
compare the actual outcome for the one or more users to the desired outcome of the one or more users; and
update the selected one or more knowledge pyramids based on the actual outcome for the one or more users.

18. The one or more storage media of claim 13, wherein the optimal situation model attributes of the one or more users comprise chemical characteristics, biological characteristics, psychological characteristics, and sociological characteristics.
